(19) United States
(12) Patent Application Publication
(10) Pub. No.: US 2025/0139718 A1
(43) Pub. Date: May 1, 2025

(54) SYSTEMS AND METHODS FOR USING AGGREGATED HOUSING DATA TO PROVIDE PERSONALIZED HOME IMPROVEMENT RECOMMENDATIONS

(71) Applicant: Wells Fargo Bank, N.A., San Francisco, CA (US)

(72) Inventors: Maria Castro, Chandler, AZ (US); Matthew Tyler Hord, Stanley, NC (US)

(21) Appl. No.: 18/494,566

(22) Filed: Oct. 25, 2023

(51) Int. Cl. G06Q 50/08; H04L 67/306

(52) U.S. Cl. CPC G06Q 50/08; H04L 67/306

(57) ABSTRACT

Systems, apparatuses, methods, and computer program products are disclosed for using aggregated housing data to provide personalized home improvement recommendations. An example method includes receiving, by communications hardware, information regarding a target property associated with a user and aggregating, by the communications hardware, supplementary housing data. The example method further includes determining, by an improvement recommendation engine, an insight regarding the target property based on the information regarding the target property and the supplementary housing data and generating, by the improvement recommendation engine and based on the insight, a home improvement recommendation. The example method further includes storing, by the improvement recommendation engine, the home improvement recommendation in a home repair profile and transmitting, by the communications hardware and based on the home improvement recommendation, a home repair notification to a user device.

### BACKGROUND

Home improvement and home repair projects are often necessary to maintain and/or improve a home. However, various issues and shortcomings exist that make it difficult to identify when and/or how to proceed with a home improvement or repair project.

### BRIEF SUMMARY

Proceeding with home improvement and/or home repair projects (e.g., installing a new fence, painting the interior or exterior of a home, landscaping the backyard, remodeling a bathroom or kitchen, installing a new roof, or the like) may be expensive, thereby causing individuals (e.g., a home owner, mortgage underwriter, and/or the like) to view the home improvement process as a daunting task associated with home ownership. In addition, varying rates from contractors, various companies, or the like, may make it difficult for an entity (e.g., a financial institution, an individual, or the like) to ascertain an individual's ability to finance a particular home repair and/or home improvement project.

Further, due to a lack of available information (e.g., data pertaining to the potential benefits and costs associated with a particular home improvement or renovation project, when/how to repair particular features of a property, or the like), an individual may not be able to confidently predict when, how, and/or even if they should to proceed with a home improvement project and/or home renovation project. For example, a particular feature of a property (e.g., the roof, flooring, yard, HVAC system, and/or the like) may not exhibit physical characteristics that indicate a need for repair thus limiting an individual's ability to identify a need for repair and when to proceed with a home improvement project. In another example, lack of knowledge of various prices associated with a home improvement project (e.g., various prices provided by contractors), and/or the like, may make it difficult for an individual to determine if they can financially support proceeding with a home improvement project. In yet another example, homeowners may lack the access to resources (e.g., data) that may be used to determine whether they should proceed with a home improvement project and/or home repair project, such as an analysis that describes the benefits associated with proceeding with the project, which can then be compared against the expected costs.

While a single-variable method for evaluating whether to proceed with a home repair or home improvement prediction method (such as a method based solely on the age of a particular feature of a house) may predict a need for repair or improvement of certain features of the house, current implementations of home repair or home improvement prediction methods have blind spots that limit their ability to provide a personalized home repair profile that may deviate from simplistic rules of thumb. For example, age analysis may account for the wear and tear a particular feature of a house, such as a HVAC unit, undergoes over time; however, age analysis does not provide any insight into an individual's ability to finance a particular repair (e.g., a cost-benefit analysis), or whether there are unique circumstances in the region that alter the default age-related metrics (e.g., water heaters in certain climates may deteriorate more quickly due to the hardness of the local water).

The inherent blind spots associated with routine single-variable methods present a technical problem. As such, a need exists for a data driven solution that can provide actionable insights in real time at scale to provide personalized home improvement recommendations. Example embodiments provide a technical solution to this technical problem because example embodiments do not require manual intervention. By leveraging aggregated transaction data and deriving valuable insights from aggregated data, example embodiments provide a technical solution ensuring the generation of personalized home improvement recommendations for nuanced repair needs in real-time.

Example embodiments described herein alleviate the issues discussed above by combining home improvement and home repair identification techniques that leverage a variety of different types of data to personalize the home improvement a process. To do so, example embodiments may receive information regarding a target property, such as a picture of the target property or feature of the target property, an address of the target property, and/or the like. Example embodiments may also aggregate supplementary housing data. In some embodiments, the supplementary housing data may provide home improvement information regarding a plurality of other properties and the previous home improvement and home repairs and recommendation associated with those properties.

Example embodiments may determine an insight regarding the target property based on the information regarding the target property and the supplementary housing data. In some embodiments, the insight may describe a need for home repair and/or a need for home improvement. The insight may further describe why there is a particular need for home improvement or need for repair. For example, the determined insight may describe a need for a roof improvement because the supplementary dataset indicated that 60% of the houses within a 5 mile radius of the target property have replaced their roofs within the last three years. Example embodiments may also generate a home improvement recommendation. The home improvement recommendation may be generated based on the determined insight. In some embodiments, a plurality of candidate recommendations may be derived based on the insight. Continuing the example where the determined insight describes a need for roof repair, the plurality of candidate recommendations may describe potential roof repair companies a user may elect to use to resolve the determined insight. In some embodiments, a home impact score may be calculated for each of the candidate recommendations included in the plurality of candidate recommendations. As such, the home improvement recommendation may be generated based on whether a particular candidate recommendation's impact score satisfies a predetermined threshold and/or based upon which of the plurality of candidate recommendations has the highest impact score.

Example embodiments may also store the home improvement recommendation in a home repair profile. In some embodiments, the home repair profile may store multiple home improvement recommendations. In this regard, a user may select a particular home improvement recommendation or the particular home improvement recommendation may be automatically selected based on the impact score associated with the particular home improvement recommendation. Example embodiments may also transmit a home repair notification to a user device associated with the user. The home repair notification may be pushed to the user device via an application, via an email, and/or the like. In some embodiments, the home repair notification may be pushed to the user device in response to the automatic selection or manual selection of a home improvement recommendation. In some embodiments, the home repair notification may include a generated home improvement graphic that illustrates the home improvement recommendation to the user. In this regard, the home improvement graphic may comprise the target property and the home improvement recommendation associated with the target property such that the home improvement recommendation overlays an illustration of the target property. If a plurality of home improvement recommendations are included in the home repair profile, the home improvement graphic may include illustrations of the plurality of home improvement recommendations overlaying the target property. In such an embodiment, since the home improvement graphic comprises a plurality of illustrations of home improvement recommendations, each home improvement recommendation may be illustrated in a unique format (e.g., each home improvement recommendation may be illustrated as a particular color, texture, pattern, a combination of a color, texture, and/or pattern, and/or the like). Alternatively, each home improvement recommendation may be illustrated in the same format (e.g., any need for repair for the target property may be illustrated on the home improvement graphic as the color red).

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used.

FIG. 2 illustrates a schematic block diagram of example circuitry embodying a system device that may perform various operations in accordance with some example embodiments described herein.

FIG. 3 illustrates an example flowchart for using aggregated housing data to provide personalized home improvement recommendations, in accordance with some example embodiments described herein.

FIG. 4 illustrates an example flowchart for identifying a home repair trend relevant to the target property, in accordance with some example embodiments described herein.

FIG. 5 illustrates an example flowchart for identifying a home repair trend relevant to the target property, in accordance with some example embodiments described herein.

FIG. 6 illustrates an example flowchart for selecting a particular candidate recommendation as the home improvement recommendation, in accordance with some example embodiments described herein.

FIG. 7 illustrates an example home repair profile used in some example embodiments described herein.

FIG. 8 illustrates an example user interface used in some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

### System Architecture

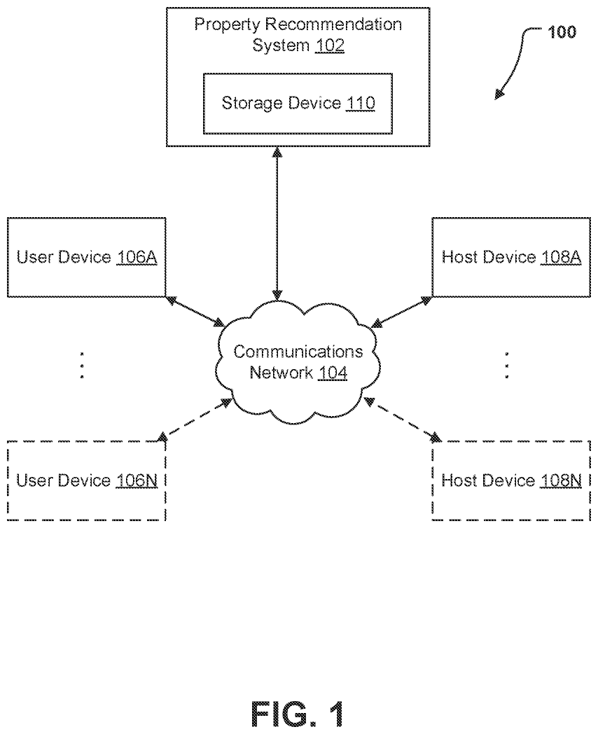

Example embodiments described herein may be implemented using any of a variety of computing devices or servers. To this end, FIG. 1 illustrates an example environment 100 within which various embodiments may operate. As illustrated, a property recommendation system 102 may receive and/or transmit information via communications network 104 (e.g., the Internet) with any number of other devices, such as one or more of user devices 106A-106N and/or host devices 108A-108N.

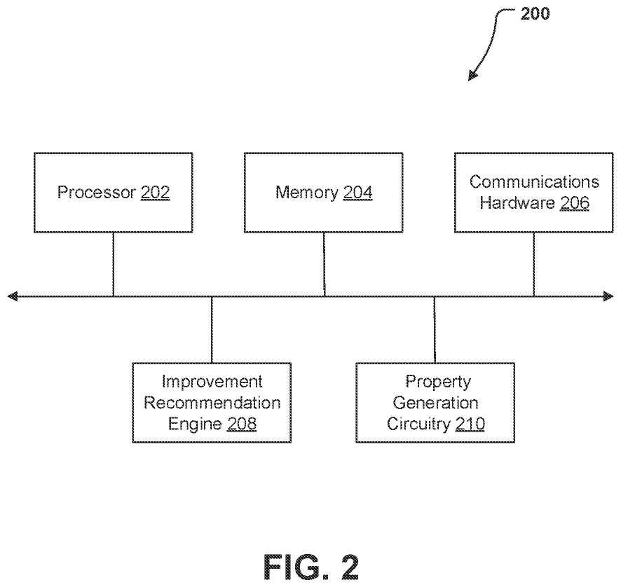

The property recommendation system 102 may be implemented as one or more computing devices or servers, which may be composed of a series of components. Particular components of the property recommendation manager 102 are described in greater detail below with reference to apparatus 200 in connection with FIG. 2.

In some embodiments, the property recommendation system 102 further includes a storage device 110 that comprises a distinct component from other components of the property recommendation system 102. Storage device 110 may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 104). Storage device 110 may host the software executed to operate the property recommendation system 102. Storage device 110 may store information relied upon during operation of the property recommendation system 102, such as various algorithms that may be used by the property recommendation system 102, data and documents to be analyzed using the property recommendation system 102, or the like. In addition, storage device 110 may store control signals, device characteristics, and access credentials enabling interaction between the property recommendation system 102 and one or more of the user devices 106A-106N or host devices 108A-108N.

The one or more user devices 106A-106N and the one or more host devices 108A-108N may be embodied by any computing devices known in the art. The one or more user devices 106A-106N may be associated with an individual. However, the one or more host devices 108A-108N may be associated with a financial institution (e.g., a bank, mortgage servicer, or the like). The one or more user devices 106A-106N and the one or more host devices 108A-108N need not themselves be independent devices, but may be peripheral devices communicatively coupled to other computing devices.

### Example Implementing Apparatuses

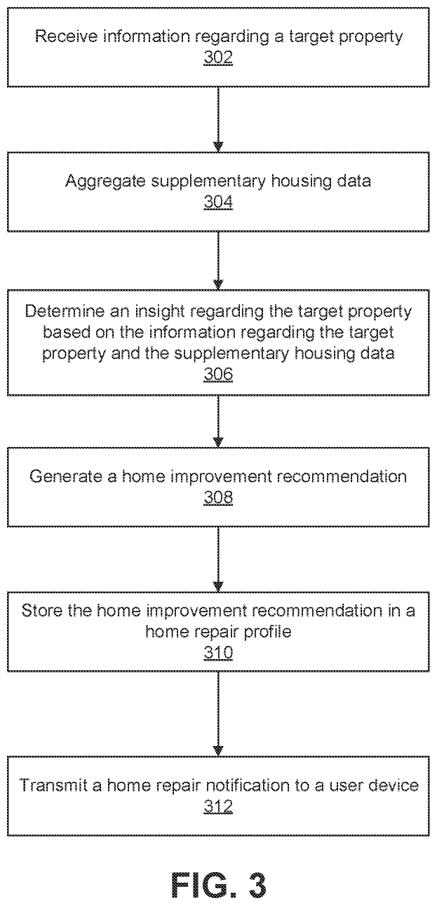

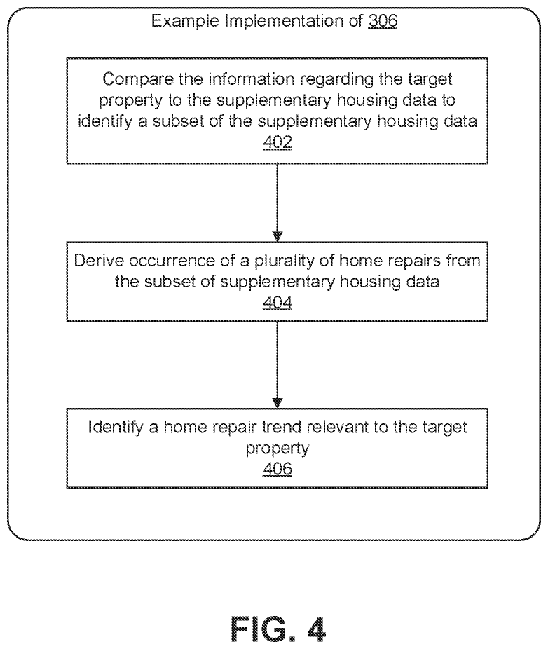

The property recommendation system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 3-4. As illustrated in FIG. 2, the apparatus 200 may include processor 202, memory 204, communications hardware 206, improvement recommendation engine 208, and property generation circuitry 210, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises an improvement recommendation engine 208 that determines an insight regarding the target property based on the information regarding the target property and the supplementary housing data. In addition, the improvement recommendation engine 208 may generate a home improvement recommendation based on the determined insight. The improvement recommendation engine 208 may also store the home improvement recommendation in a home repair profile. The improvement recommendation engine 208 may utilize processor 202, memory 204, or any other hardware component included in the apparatus 200 to perform these operations, as described in connection with FIGS. 3-6 below. The improvement recommendation engine 208 may further utilize communications hardware 206 to gather data from a variety of sources (e.g., user device 106A through user device 106N or host device 108A through host device 108N, as shown in FIG. 1), and/or exchange data with a user, and in some embodiments may utilize processor 202 and/or memory 204 to perform any or more of the above operations.

In addition, the apparatus 200 further comprises a property generation circuitry 210 that generates a home improvement graphic based on a home improvement recommendation. The property generation circuitry 210 may utilize processor 202, memory 204, or any other hardware component included in the apparatus 200 to perform these operations, as described in connection with FIG. 3 below. The property generation circuitry 210 may further utilize communications hardware 206 to gather data from a variety of sources (e.g., user device 106A through user device 106N or host device 108A through host device 108N, as shown in FIG. 1), and/or exchange data with a user, and in some embodiments may utilize processor 202 and/or memory 204 to perform any or more of the above operations.

Although components 202-210 are described in part using functional language, it will be understood that the particular implementations necessarily include the use of particular hardware. It should also be understood that certain of these components 202-210 may include similar or common hardware. For example, the improvement recommendation engine 208 and property generation circuitry 210 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry” and “engine” with respect to elements of the apparatus therefore shall be interpreted as necessarily including the particular hardware configured to perform the functions associated with the particular element being described. Of course, while the terms “circuitry” and “engine” should be understood broadly to include hardware, in some embodiments, the terms “circuitry” and “engine” may in addition refer to software instructions that configure the hardware components of the apparatus 200 to perform the various functions described herein.

Although the improvement recommendation engine 208 and property generation circuitry 210 may leverage processor 202, memory 204, or communications hardware 206 as described above, it will be understood that any of improvement recommendation engine 208 and property generation circuitry 210 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that improvement recommendation engine 208 and property generation circuitry 210 comprise particular machinery designed for performing the functions described herein in connection with such elements of apparatus 200.

In some embodiments, various components of the apparatus 200 may be hosted remotely (e.g., by one or more cloud servers) and thus need not physically reside on the corresponding apparatus 200. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of example apparatuses 200, example embodiments are described below in connection with a series of flowcharts and a graphical user interface.

### Example Operations

Turning to FIGS. 3-6, example flowcharts are illustrated that contain example operations implemented by example embodiments described herein. The operations illustrated in FIGS. 3-6 may, for example, be performed by the property recommendation system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, improvement recommendation engine 208, property generation circuitry 210, and/or any combination thereof. It will be understood that user interaction with the property recommendation system 102 may occur directly via communications hardware 206, or may instead be facilitated by a separate user device 106A-106N, as shown in FIG. 1, and which may have similar or equivalent physical componentry facilitating such user interaction.

Turning first to FIG. 3, example operations are shown for using aggregated housing data to provide personalized home improvement recommendations.

As shown by operation 302, the apparatus 200 includes means, such as memory 204, communications hardware 206, or the like, for receiving information regarding a target property. Receipt of the information regarding a target property may trigger the apparatus 200 to provide a property personalized home improvement recommendations (as described in greater detail below) for the target property. The received information regarding a target property may include data that identifies the target property using its address, geographical coordinates of its location, and may further include additional details regarding the target property, such as the type of target property (e.g., house, apartment, condo, and/or the like), existing appliances in the target property (e.g., HVAC, water heater, and/or the like), a history of energy usage associated with the target property, age of the target property, an indication of the user that transmitted the received information regarding the target property (e.g., an individual, a bank, or the like), and/or the like, such that the apparatus 200 may provide personalized home improvement recommendations associated with the target property.

In some embodiments, the apparatus 200 (e.g., communications hardware 206) may receive the information regarding a target property from another computing device (e.g., user device 106A through user device 106N, or the like) via a network (e.g., communications network 104, shown in FIG. 1). Subsequently, the apparatus 200 may store the information regarding a target property in a local storage device, such as memory 204, storage device 110, or the like. Accordingly, in some embodiments the apparatus 200 may receive the information regarding a target property from memory 204 after having previously stored it.

In some embodiments, the communications hardware 206 may transmit an electronic request (hereinafter referred to as a property improvement request) to a computing device (e.g., user device 106A, user device 106N, or the like) via a network (e.g., communications network 104, shown in FIG. 1) that instructs the user associated with the computing device to transmit particular information regarding the target property. In response, the apparatus 200 may subsequently receive the above-referenced information about the target property. In some embodiments, an automatic trigger event may cause communications hardware 206 to transmit the property improvement request. An automatic trigger event may include a temporal trigger event, circumstantial trigger event, and/or the like. A temporal trigger event may take place based on rules and/or configurations that require the transmission of a property improvement request within a particular time period or at a particular point in time. In some embodiments, a set of property improvement rules may be stored in a local storage device (e.g., memory 204, storage device 110, and/or the like) and may describe a set of conditions that, if satisfied, cause the transmission of a property improvement request (e.g., the activation of an automatic trigger). For example, the apparatus 200 may retrieve a set of property improvement rules from memory 204 that indicates that if a target property's roof is over 15 years old, a temporal trigger may cause the transmission of a property improvement request that requests information regarding the roof of the target property (e.g., a picture of the roof, a text description of the quality of the roof, or the like).

In addition, a circumstantial trigger event may take place based on rules and/or configurations that cause the transmission of a property improvement request in response to a set of conditions and/or criteria (e.g., conditions and/or criteria described in the set of property improvement rules) being met. For example, a circumstantial trigger may describe that the transmission of a property improvement request may occur if a first received information regarding a target property does not include particular information regarding the target property that may be required to identify a particular personalized home improvement or repair need, such as an address, user information, or the like. Both temporal and circumstantial triggers comprise types of automatic triggers that may a process flow triggering occurrence of operation 302.

Following operation 302, the procedure advances to operation 304, in which the apparatus 200 includes means, such as memory 204, communications hardware 206, improvement recommendation engine 208, or the like, for aggregating supplementary housing data. The supplementary housing data may comprise data that describes transactions associated with previous property improvement projects for a plurality of improvement projects associated with a plurality of properties. In addition, the supplementary housing data may include data about the sale of particular properties. For example, the supplementary housing data may include transaction data (e.g., the date and time of a transaction, transaction amount, transaction type, an indicator of the parties involved in the transaction, or the like). For example, assume user A, user B, and user C, are associated with transaction data included in the supplementary housing data. Continuing the above example, user A may be associated with a transaction with a roofing company, user B may be associated with a series of transaction to a flooring company, and user C may be associated with a series of transactions associated with a kitchen appliance vendor. In addition, the supplementary housing data may include information regarding the sale (e.g., date of the sale, the selling price of the house, or the like) of the property associated with user A, user B, and user C. Further, the supplementary housing data may include transaction data associated with businesses that provide property improvement services. For example, the supplementary housing data may include transaction data associated with a roof repair company, a landscaping company, a flooring company, a plumbing business, an electrician, and/or the like.

In some embodiments, communications hardware 206 may aggregate supplementary housing data from local storage devices (e.g., memory 204, storage device 110, or the like), external storage devices (e.g., storage devices associated with a financial institution, such as a bank), and/or the like. For example, communications hardware 206 may transmit a supplementary housing data aggregation request to a computing device (e.g., host device 108A, host device 108N, or the like) associated with a financial institution via a communications network (e.g., communications network 104, shown in FIG. 1) to aggregate the supplementary housing data. The supplementary housing data aggregation request may comprise any necessary data required by an external storage device to aggregate the supplementary housing data, such as authentication information, information about the requested data, and/or the like.

In some embodiments, the aggregated data may comprise a plurality of transaction data extending beyond transaction data solely pertaining to home improvement projects. In such an embodiment, improvement recommendation engine 208 may filter the aggregated data by filtering the transaction data that is not associated with home improvement projects. For example, improvement recommendation engine 208 may isolate the field associated with the parties involved in particular transactions and, based on the parties involved in the transaction, determine whether the particular transaction data is associated with home improvement projects. Continuing the above example, improvement recommendation engine 208 may use a set of known home improvement parties to filter a plurality of transaction data. In some embodiments, the set of known home improvement parties may be stored in a local storage device (e.g., memory 204, storage device 110, or the like) and later retrieved by the improvement recommendation engine 208 to filter transaction data that does not indicate a party included in the set of known home improvement parties.

As shown by operation 306, the apparatus 200 includes means, such as memory 204, improvement recommendation engine 208, or the like, for determining an insight regarding the target property based on the information regarding the property and the supplementary housing data. In some embodiments, the insight may describe a home repair and/or home improvement need for the target property. The insight may be determined based on the occurrence of a particular home repair derived from the supplementary housing data in a similar property (e.g., within a particular radius of the target property, a similar age of the target property, or the like) to the target property. For example, assume the information regarding a target property describes the address and age of a property and the supplementary housing data comprises data that describes kitchen renovations that were recently completed for more than 60% of the properties in the same age range (e.g., 10-15 years) and within a 1 mile radius around the target property. As a result, the insight may describe an improvement recommendation to renovate the kitchen of the target property.

Example operations for determining an insight are described further below in relation to FIG. 4. Turning now to FIG. 4, example operations are shown identifying a home repair trend relevant to the target property.

As shown by operation 402, the apparatus 200 includes means, such as memory 204, improvement recommendation engine 208, or the like, for comparing the information regarding the target property to the supplementary housing data to identify a subset of the supplementary housing data. In some embodiments, improvement recommendation engine 208 may retrieve the information regarding the target property from a local storage device (e.g., memory 204, storage device 110, or the like). Improvement recommendation engine 208 may use techniques such as optical character recognition (OCR), natural language processing (NLP), searching algorithms, machine learning models, and/or the like to identify information included in the information regarding the target property that may subsequently be used to identify a subset of supplementary housing data that includes data about one or more properties included in the supplementary housing data that are most-similar (e.g., within a particular radius of the target property, a similar age of the target property, or the like) to the target property. For example, assume the information regarding a target property includes the target property's address, a user identifier that identifies the user associated with the computing device (e.g., user device 106A, host device 108A, or the like) that transmitted the information regarding a target property or another user (e.g., a bank transmitting the property improvement data packed to determine whether a particular individual can afford necessary home improvements or repair), and the age of the house. Improvement recommendation engine 208 may then leverage a named entity recognition (NER) machine learning model that classifies the information included in the information regarding a target property. By means of continuing example, the NER machine learning model may classify the address of the target property as a “location”, the user identifier as a “person”, and the age of the house as an “age”.

In some embodiments, the improvement recommendation engine 208 may compare the classified entities derived from the information regarding the target property to the set of supplementary housing data to identify a subset of the supplementary housing data. In this regard, improvement recommendation engine 208 may search the supplementary housing data for particular data that is associated with the classified entities derived from the information regarding the target property. If needed, improvement recommendation engine 208 may leverage techniques such as optical character recognition (OCR), natural language processing (NLP), searching algorithms, machine learning models, and/or the like, to identify data included in the supplementary housing data that may be used to determine the insight. For example, improvement recommendation engine 208 may leverage a named entity recognition (NER) machine learning model that classifies the data included in the supplementary housing data. Improvement recommendation engine 208 may then search the supplementary housing data for categories that are associated with the classified entities derived from the information regarding the target property. For example, assume the information regarding the target property includes location data about the target property that describes the target property's location as “Middlesex County, Massachusetts”. As a result, improvement recommendation engine 208 may search the classified supplementary housing data and leverage a technique such as OCR to identify an indicator, such as “location”, and subsequently search for the location “Middlesex County, Massachusetts” to identify the data elements included in the supplementary housing data that are associated with this location.

In some embodiments, improvement recommendation engine 208 may reference a set of predetermined rules (e.g., predetermined rules derived from historical analysis of previous home repair or improvement projects) that are stored in a local storage device (e.g., memory 204, storage device 110, or the like) to determine which parameters to consider when identifying a subset of supplementary housing data. As a result, improvement recommendation engine 208 may generate a subset of the supplementary housing data, such that the subset of the supplementary housing data includes data about particular properties that are similar to the target property based on the set of predetermined rules. For example, assume the information regarding the target property included the geographical coordinates of the target property. Improvement recommendation engine 208 may retrieve the set of predetermined rules from memory 204 and identify a particular radius around the target property that the one or more properties included in the subset of supplementary housing data should be within. Additionally or alternatively, improvement recommendation engine 208 may use each classified entity included in the information about the target property to identify a subset of the supplementary housing data.

In some embodiments, improvement recommendation engine 208 may complete a filtering operation (e.g., a comparison of the information regarding the target property to the supplementary housing data) for each labeled entity included in the information regarding a target property to identify data elements to include in one or more subsets of the supplementary housing data. The filtering operations may be based on a set of predetermined filtering rules stored in a local storage device (e.g., memory 204, storage device 110, or the like). The set of predetermined filtering rules may be predetermined by the entity (e.g., a financial institution) that is providing home improvement recommendations. For example, the predetermined filtering rules may be derived by historical analysis of particular properties (e.g., analysis of historical information, such as previous home repairs regarding the particular properties). For example, improvement recommendation engine 208 may identify one or more particular home repair needs that arise as properties age by identifying the history of repair needs for particular properties of various ages. For example, through analysis of historical data associated with particular properties of various ages, improvement recommendation engine 208 may determine that properties between the ages of 0-9 years usually do not have roofing repair needs, properties between the ages of 10-19 years exhibit roofing repair needs, and properties between the ages of 20-29 years do not exhibit roofing repair needs, however, the properties between the ages of 20-29 have a history of a roof repair.

As a result of one or more filtering operations based on the set of predetermined filtering rules, the subset of supplementary housing data may include data about particular properties included in the subset of supplementary housing data that are the most-similar to the target property. In some embodiments, a separate subset of supplementary housing data may be generated for each filtering operation. Alternatively, the subset of supplementary housing data may include data about the particular properties that successfully completed and/or survived a plurality of filtering operations. For example, assume the information about a target property includes the age of the target property and the location of the target property. The subset of supplementary housing data may then include data about particular properties of a similar age (e.g., an age range described by the set of predetermined filtering rules) of the target property, properties within a predefined radius around the target property, and/or particular properties that are both of similar age and within a predefined radius about the target property.

Additionally or alternatively, improvement recommendation engine 208 may reference data that describes instructions (e.g., stored in a local storage device, such as memory 204, storage device 110, or the like) included in the information regarding a target property that may specify to use a particular comparison and/or filtering operation to determine the insight. For example, a particular user may provide data about the roof of the target property and further specify in the information regarding the target property to include data from across New England to determine a personalized home improvement recommendation.

As shown by operation 404, the apparatus 200 includes means, such as memory 204, improvement recommendation engine 208, or the like, for deriving occurrence of a plurality of home repairs from the subset of supplementary housing data. In some embodiments, improvement recommendation engine 208 may leverage a model to derive the occurrence of a plurality of home repairs. For example, improvement recommendation engine 208 may leverage a machine learning classifier to identify a plurality of home repairs included in the subset of supplementary housing data. In this regard, the machine learning classifier may be trained with labeled transaction data (e.g., transaction data that is tagged with a particular type of home improvement/repair) to identify a plurality of home repairs from the transaction data included in the subset of supplementary housing data. For example, the machine learning classifier may reference the transaction amount, location, parties involved in the transaction, or the like, to classify a particular transaction included in the subset of supplementary housing data as a particular home repair. In some embodiments a singular machine learning classifier may be trained to classify a plurality of home repairs. Alternatively, improvement recommendation engine 208 may leverage a plurality of machine learning model classifiers, each configured to identify a particular home repair.

Additionally or alternatively, improvement recommendation engine 208 may leverage a rules-based model to identify a plurality of home repairs. For example, the rules-based model may be configured to identify a particular home repair based on the parties associated with a particular transaction. As a result, the rules-based model may reference the set of known home improvement parties that describes one or more parties of a transaction (e.g., contractors, landscapers, plumbers, or the like) and the home repair type that they are associated with to identify the plurality of home repairs. In some embodiments, the set of known home improvement parties may be stored in a local storage device (e.g., memory 204, storage device 110, or the like). As such, improvement recommendation engine 208 may input the subset of supplementary housing data and the set of known home improvement parties into the rules-based model and the rules-based model may output an occurrence of a plurality of home repairs.

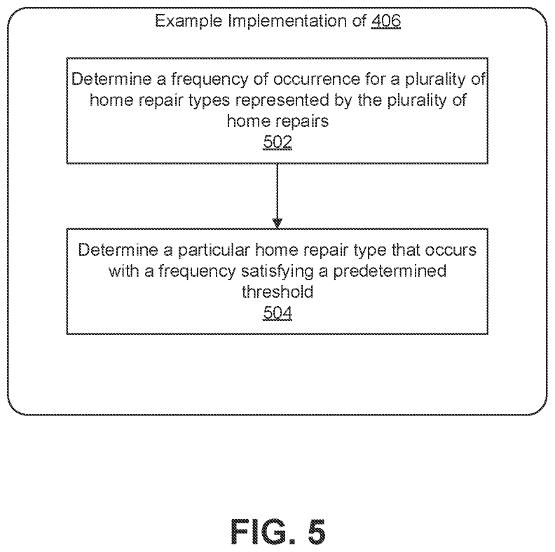

As shown by operation 406, the apparatus 200 includes means, such as memory 204, improvement recommendation engine 208, or the like, for identifying a home repair trend relevant to the target property. In some embodiments, after identifying the plurality of home repairs (e.g., described above in relation to operation 404), improvement recommendation engine 208 may identify the occurrence of each home repair type (e.g., roof repair, sewer line repair, kitchen renovation, pool renovation, or the like) included in the plurality of home repairs. Turning now to FIG. 5, example operations are shown for identifying a home repair trend relevant to the target property.

As shown by operation 502, the apparatus 200 includes means, such as memory 204, improvement recommendation engine 208, or the like, for determining a frequency of occurrence for a plurality of home repair types represented by the plurality of home repairs. A home repair type may describe a particular category a home repair may be sorted into. For instance, some example home repair types may be a roof repair, pool renovation, driveway renovation, a kitchen renovation, or the like. In some embodiments, improvement recommendation engine 208 may determine a home repair type based on the parties involved in a particular transaction included in the subset of the supplementary housing data. For example, if a particular home repair is completed by a known roofing company (e.g., the party or counterparty in a transaction is a known roofing company) and the known roofing company is included in the set of known home improvement parties, improvement recommendation engine 208 may automatically identify the home repair type as a roof repair. In some embodiments, improvement recommendation engine 208 may calculate a numerical value via a summation for the occurrence of each home repair type included in the plurality of home repairs.

As shown by operation 504, the apparatus 200 includes means, such as memory 204, improvement recommendation engine 208, or the like, for determining a particular home repair type that occurs with a frequency satisfying a predetermined threshold. In some embodiments, improvement recommendation engine 208 may reference a set of predetermined thresholds. The predetermined thresholds may comprise of conditions that, when satisfied, identify a home repair trend. Said another way, the predetermined insight thresholds may describe a condition, such as a particular frequency of occurrence of a particular home repair included in the plurality of home repairs, and if the particular frequency (e.g., a particular numerical value for the frequency of the particular home repair, or the like) is met, a home repair trend is identified. For example, the predefined threshold may describes a condition to identify a home repair trend if a particular home repair occurs the most in the plurality of home repairs.

Returning to FIG. 3, as shown by operation 308, the apparatus 200 includes means, such as memory 204, improvement recommendation engine 208, or the like, for generating a home improvement recommendation. The home improvement recommendation may describe a particular path a user may partake to alleviate the determined insight and improve the property value of their property. As such, the home improvement recommendation is based on the insight and subset of supplementary housing data. In particular, the data elements included in the subset of supplementary housing data that describe a particular home improvement party that was used to alleviate the determined insight.

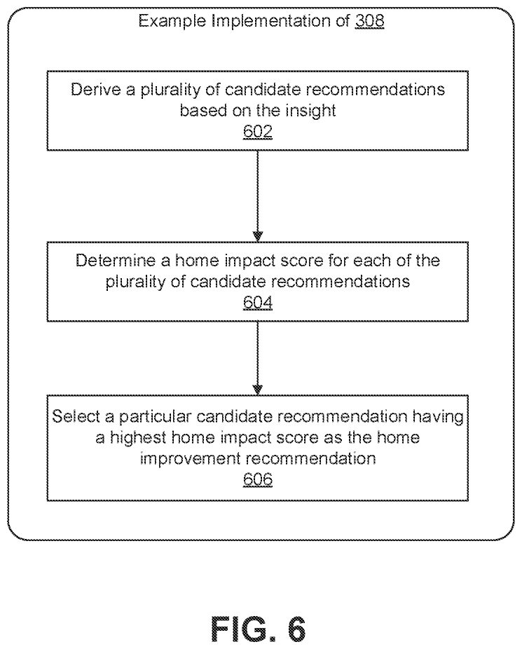

Example operations for generating the home improvement recommendation are described further below in relation to FIG. 6. Turning now to FIG. 6, example operations are shown for selecting a particular candidate recommendation as the home improvement recommendation.

As shown by operation 602, the apparatus 200 includes means, such as memory 204, improvement recommendation engine 208, or the like, for deriving a plurality of candidate recommendations based on the insight. The plurality of candidate recommendations may describe potential paths (e.g., known home improvement parties) a user may take to resolve the determined insights. In some embodiments, improvement recommendation engine 208 may derive a plurality of candidate recommendations from the determined insight. For example, the improvement recommendation engine 208 may reference the data elements (e.g., an indication of the parties involved in the transaction) associated with the subset of the supplementary housing data that is related to the home repair trend (e.g., the determined insight) to identify a particular home improvement party for the determined insight.

In some embodiments, if the subset of supplementary housing data indicates a plurality of home improvement parties, improvement recommendation engine 208 may then identify a plurality of candidate recommendations based on the plurality of identified parties involved resolving the determined insight. For example, assume the data elements included in the subset of the supplementary housing data that indicate the home repair trend (e.g., a roof repair) indicate transactions to various roof repair companies, such as roof repair company A, roof repair company B, and roof repair company C. In this regard, improvement recommendation engine 208 may identify roof repair company A, roof repair company B, and roof repair company C as candidate recommendations included in a plurality of candidate recommendations.

As shown by operation 604, the apparatus 200 includes means, such as memory 204, improvement recommendation engine 208, or the like, for determining a home impact score for each of the plurality of candidate recommendations. A home impact score may indicate a projected outcome (e.g., an increase in property value) associated with selecting a particular candidate recommendation. In some embodiments, the home impact score may be a computed numerical score. As such, the home impact score may be determined by a scoring model.

In some embodiments, improvement recommendation engine 208 may leverage the scoring model to determine the home impact score for each of the plurality of candidate recommendations. To do so, improvement recommendation engine 208 may retrieve the data elements included in the subset of the supplementary housing data that are associated with the home repair trend and candidate recommendation (e.g., the amount of the transaction, date of the transaction, parties involved, or the like). In addition, improvement recommendation engine may retrieve data about the sale of the particular property that is associated with the home repair trend and candidate recommendation. Further, improvement recommendation engine 208 may retrieve data (e.g., data about the sale of properties) from the subset of supplementary housing data that is not related to the home repair trend. Once the data is retrieved from a storage device (e.g., memory 204, storage device 110, and/or the like) improvement recommendation engine 208 may input the retrieved data elements into the scoring model. In some embodiments, the scoring model may output a home impact score based for each of the plurality of candidate recommendations based on the property value increase associated with each candidate recommendation. The property value increase may be calculated based on the data regarding the sale of the property that resolved the determined insight and the data regarding the sale of the property that did not resolve the determined insight. In some embodiments, the scoring model may also account for the time until completion of the home improvement project, the cost of the home improvement project, and/or the like, while calculating the home impact score.

As shown by operation 606, the apparatus 200 includes means, such as memory 204, improvement recommendation engine 208, or the like, for selecting a particular candidate recommendation having a highest home impact score as the home improvement recommendation. Improvement recommendation engine 208 may sort the home impact scores for the plurality of candidate recommendations and subsequently select the particular candidate recommendation having a highest home impact score as the home improvement recommendation. For example, assume the plurality of candidate recommendations include candidate recommendation A with a home impact score of 0.1, candidate recommendation B with a home impact score 0.6, and candidate recommendation with a home impact score of 0.9. As a result, improvement recommendation engine 208 may select candidate recommendation C as the home improvement recommendation.

Returning to FIG. 3, as shown by operation 310, the apparatus 200 includes means, such as memory 204, communications hardware 206, improvement recommendation engine 208, or the like, for storing the home improvement recommendation in a home repair profile. The home repair profile may be a data structure that comprises the home improvement recommendation. In some embodiments, the home repair profile may store multiple home improvement recommendations. For example, although described in relation to a singular insight, improvement recommendation engine 208 may determine multiple insights in operation 304. In this regard, each insight included in the multiple insights may be associated with a home improvement recommendation and thus the home repair profile may store multiple home improvement recommendations. In some embodiments, improvement recommendation engine 208 may automatically select the home improvement recommendation from multiple home improvement recommendations included in the home repair profile based on the home impact score associated with each of the multiple home improvement recommendations.

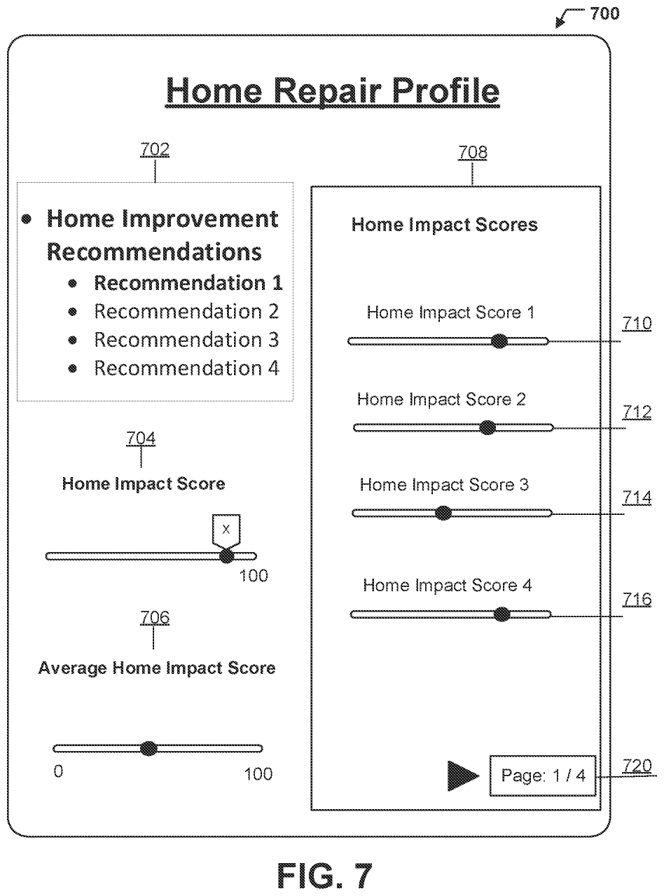

Additionally or alternatively, communications hardware 206 may transmit a home improvement selection request to the user device. The home improvement selection request may be an electronic form that includes the multiple home improvement recommendations included in the home repair profile and requests input from the user to manually select a home improvement recommendation. The home improvement selection request may be transmitted by communications hardware 206 to the computing device associated with the user (e.g., user device 106A, or the like) via a network (e.g., communications network 104, shown in FIG. 1). Subsequently, the apparatus 200 may receive a selection from the user device. In some embodiments, the selection may be received by communications hardware 206 via a network. The home repair profile may comprise graphics/illustrations to illustrate the home improvement recommendations. An example home repair profile is shown and described below in relation to FIG. 7.

As shown by operation 312, the apparatus 200 includes means, such as memory 204, communications hardware 206, property generation circuitry 210, or the like, for transmitting a home repair notification to the user device (e.g., user device 106A, user device 106N, or the like). In some embodiments, the home repair notification may be an electronic notification, such as an email, a text, and/or a notification pushed to the computing device (e.g., user device 106A or the like) associated with the user via an application, that is transmitted to the computing device associated with the user via a network (e.g., communications network 104, shown in FIG. 1.). In some embodiments, the home repair notification may be transmitted to the user device in response to automatic selection of the home improvement recommendation. Additionally or alternatively, the home repair notification may be transmitted to the user device in response to receipt of the selection including the home improvement recommendation.

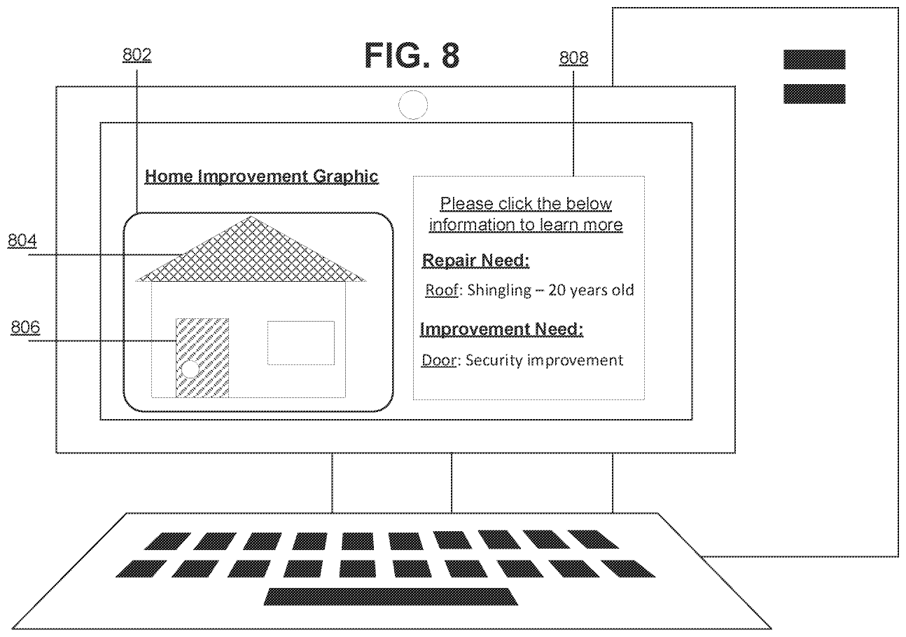

The home repair notification may contain more granular information regarding the selected home improvement recommendation, such as additional information included in the home repair profile or otherwise available to the apparatus 200. In some embodiments, the home repair notification may further include a home improvement graphic. The home improvement graphic may depict the home improvement recommendation, the target property, and/or the like. For example, the home improvement graphic may illustrate a three dimensional (3D) or two dimensional (2D) depiction of the target property by leveraging a conditional generative adversarial network (cGAN). An example home improvement graphic is illustrated and described below in relation to FIG. 8.

In some embodiments, the property generation circuitry 210 may leverage a trained model, such as a cGAN that includes two neural networks in contest with each other (e.g., a generative machine learning model and a discriminator machine learning model), to generate the target property that may be illustrated on the home improvement graphic. In some embodiments, the two neural networks may be convolutional neural networks. To train the cGAN, the generator and discriminator may be trained in alternating periods. For example, the discriminator trains for one or more iterations while the generator remains constant, and then the generator trains for one or more iterations while the discriminator remains constant. The training may continue until the discriminator has a 50 percent chance of discriminating fake data (e.g., a target property) generated from the generator model from real data. In some embodiments, training of the cGAN begins when the generator receives random noise to initiate generation of the target property. In some embodiments, the random noise may be sampled from a latent space and may be formatted as a vector, array, and/or the like. The introduction of random noise enables the generator to produce a wide variety of data, sampling from different places in a predefined target distribution. In addition to the random noise, a data label may be input that conditions the generator to a variety of target properties (e.g., university buildings, residential houses, sky scrapers, apartment buildings, brownstones, or the like).

In some embodiments, the generator may generate synthetic target properties based on the input random noise and data label associated with the latent space where the random noise originates. Following generation of the synthetic target property, the data label and synthetic data may be input to discriminator. The discriminator may generate a probability based on the input data label and generated image describing the probability that the image was generated by the generator or if the image is real. For example, if the discriminator is configured to output a probability of 0 for synthetic target properties generated by the generator, and a probability of 1 for real data and the discriminator output a probability of 0.7 for the synthetic target property, the discriminator may be notified it was incorrect causing the discriminator to update its weights through backpropagation based on a calculated error. Similarly, if the discriminator was correct, the generator would be notified it failed and would update its weights through back propagation based on a calculated error.

The error may be calculated based on any loss function known in the art. By means of continuing example, the error may be calculated based on a log-loss error function where the generator and the discriminator have two different log-loss error functions that prioritize the generator to cause the discriminator to output a probability of 1 for a synthetic target property and the discriminator to output a probability of 0 for a generated image. The derivative of the error function may be used to determine the weights of both the generator's neural network and the discriminator's neural network. In addition, after the weights are updated for the generator and/or discriminator for a generated target property based on random noise, a real image (e.g., of a target property stored in storage device 110, memory 204, or the like) may be input to the discriminator enabling the discriminator to train with real data. In some embodiments, following many iterations of training the cGAN network with both real data from a local storage device and generated data based on random noise and a data label, the machine learning model may be applied to generate projections based on the information regarding the target property. Although, the cGAN is described as a singular cGAN, there may be a plurality of cGAN's trained to be applied for generating a variety of projections for a variety of target properties.

To this end, property generation circuitry 210 may retrieve information about the target property (e.g., received in operation 302 or from the home repair profile both of which may be stored in a local storage device, such as memory 204, storage device 110, or the like) and provide the information about the target property (e.g., a description of the property) to the cGAN to produce the depiction of the target property. Subsequently, the cGAN may output a depiction that illustrates the target property.

The depiction of the target property may illustrate an indication of home improvement recommendations. In this regard, a particular format, such as a color, pattern, texture, and/or the like, may be illustrated on the target property to indicate the home repair type. For example, assume the home repair profile describes a home improvement recommendation associated with a roof repair. As a result, the illustrated target property may include a depiction of a particular pattern on the roof. For example, assume the target property has a home improvement recommendation associated with a roof repair. Property generation circuitry 210 may then use a convolutional neural network (CNN) to identify the roof included in the image of the target property. For example, the home improvement graphic may be input and passed through a series of layers included in the CNN. The series of layers may include filters/kernels that detect particular features of a property. In some embodiments, the CNN may include additional layers and/or modules to propose where a particular object (e.g., a roof) may be located in the input home improvement graphic.

Following the identification of the roof, property generation circuitry 210 may leverage a model to illustrate a particular pattern on the roof that indicates the home improvement recommendation associated with the roof of the target property. In some embodiments, the model may use any suitable image processing techniques, such as texture mapping, color overlay, or the like, to illustrate a particular pattern on the location of the target property associated with the home improvement recommendation. In some embodiments, a home repair profile may include multiple home improvement recommendations. As such, the illustration of the target property may include a plurality of different patterns. Additionally or alternatively, the same format may be used to illustrate each home improvement recommendation on the illustrated target property.

FIGS. 3-6 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### Example System Interaction

Turning to FIG. 7, a graphical user interface (GUI) is provided that illustrates an example presentation of a home repair profile 700 on a computing device (e.g., user device 106A, or the like). As noted previously, a user may interact with the property recommendation system 102 by directly engaging with communications hardware 206 of an apparatus 200. In such an embodiment, the GUI shown in FIG. 7 may be displayed to a user (e.g., user device 106A through user device 106N, or the like) by the apparatus 200.

The list of home improvement recommendations 702 may group home repair suggestions in a directory (e.g., a folder), as shown in FIG. 7 as “Home Improvement Recommendations”. The home improvement recommendations directory may be selectable to expand or collapse the home improvement recommendations, and the individual home improvement recommendations may be selected to display the relevant home improvement recommendations in the example home repair profile 700.

The home impact score 704 and average home impact score may give a numerical value to the home impact score and a numerical value to the average home impact score calculated from a plurality of home impact scores. The user interface element may include a graphical reference that shows the home impact score to a scale, for example a numerical scale from 0 to 100, or the like. The graphical reference may allow a user to better gauge the home impact score in relation to the average home impact score.

The detailed information about the home impact scores 708 may include information about the each home impact score. The depicted list of home impact scores shows one possible example for a graphical comparison of home improvement recommendation with partial home impact scores 1 through 4. Other example embodiments or home repair profiles of other home improvement recommendations may list different home impact scores. Home impact scores 710, 712, 714, and 716 may be displayed with a numerical value of the respective home impact score, and a user interface element may further give a graphical representation of the score relative to some scale, for example a minimum of 0 and maximum of 100. Finally, a page selector 720 may allow the user to view additional home impact scores, the home improvement graphic, and/or the like by advancing to the next page and/or selecting a page from a listing of pages.

Turning to FIG. 8, a graphical user interface (GUI) is provided that illustrates an example presentation of a property improvement graphic on a computing device (e.g., user device 106A, host device 108A, or the like). As noted previously, a user may interact with the property recommendation system 102 by directly engaging with communications hardware 206 of an apparatus 200. In such an embodiment, the GUI shown in FIG. 8 may be displayed to a user (e.g., user device 106A through user device 106N, or the like) by the apparatus 200.

Home improvement graphic 802 may be automatically displayed to the user. In addition, roof 804 and door 806 may be illustrated on the home improvement graphic to indicate a home repair or home improvement need. A visual indicator, such as roof 804 and/or door 806 may blink to prompt the user to click or otherwise interact with the features of the house depicted with a distinct pattern indicating the home repair or home improvement need. If a user interacts with roof 804 or door 806 (e.g., hovering a cursor over the compliance graphic, clicking the compliance graphic, and/or the like), the interaction may cause additional information associated with the need for repair and/or improvement to be displayed, such as a home impact score, or the like. In addition, a text based summary 808 may display a summary of the home improvement graphic. For example, the text based summary may display a summary of the needs for repair and improvement (e.g., as indicated in the determined insights included in a home repair profile). User interaction with the text based summary 808 (e.g., hovering a cursor over the text based summary, clicking the text based summary, and/or the like) may cause additional information associated with the home impact score, or the like.

### CONCLUSION

As described above, example embodiments provide methods and apparatuses that enable improved personalized home improvement recommendations. Example embodiments thus provide tools that overcome the problems faced by property owners and financial institutions to ascertain the repair and improvement needs of a property. By avoiding the need to manually perform evaluations of each feature of a property that may require an improvement or repair, example embodiments thus save time and resources, while also eliminating the possibility of human error that has been unavoidable in the past. Moreover, embodiments described herein avoid relying on a model that accounts for one variable (e.g., age of the property) to identify an improvement or repair need. Instead, example embodiments account for a plurality of variables and leverage user information to personalize home improvement and home repair recommendations.

As these examples all illustrate, example embodiments contemplated herein provide technical solutions that solve real-world problems faced while evaluating the repair and improvement needs for a property. At the same time, the recently arising ubiquity of customer transaction data that describes home improvement and renovation project related purchases has unlocked new avenues to solving this problem that historically were not available, and example embodiments described herein thus represent a technical solution to these real-world problems.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for using aggregated housing data to provide personalized home improvement recommendations, the method comprising:
receiving, by communications hardware, information regarding a target property associated with a user;
aggregating, by the communications hardware, supplementary housing data;
determining, by an improvement recommendation engine, an insight regarding the target property based on the information regarding the target property and the supplementary housing data;
generating, by the improvement recommendation engine and based on the insight, a home improvement recommendation;
storing, by the improvement recommendation engine, the home improvement recommendation in a home repair profile; and
transmitting, by the communications hardware and based on the home improvement recommendation, a home repair notification to a user device, wherein the user device is associated with the user.

2. The method of claim 1, wherein determining the insight regarding the target property comprises:
comparing, by the improvement recommendation engine, the information regarding the target property to the supplementary housing data to identify a subset of the supplementary housing data, wherein the subset of the supplementary housing data comprises data about one or more properties included in the supplementary housing data that are most-similar to the target property;
deriving, by the improvement recommendation engine, occurrence of a plurality of home repairs from the subset of supplementary housing data; and
identifying, by the improvement recommendation engine and from the plurality of home repairs, a home repair trend relevant to the target property, wherein the home repair trend comprises the insight regarding the target property.

3. The method of claim 2, wherein identifying the home repair trend comprises:
determining, by the improvement recommendation engine, a frequency of occurrence for a plurality of home repair types represented by the plurality of home repairs;
determining, by the improvement recommendation engine, a particular home repair type that occurs with a frequency satisfying a predetermined threshold, wherein the home repair trend comprises the particular home repair type.

4. The method of claim 1, wherein generating the home improvement recommendation comprises:
deriving, by the improvement recommendation engine, a plurality of candidate recommendations based on the insight;
determining, by the improvement recommendation engine, a home impact score for each of the plurality of candidate recommendations; and
selecting, by the improvement recommendation engine, a particular candidate recommendation having a highest home impact score as the home improvement recommendation.

5. The method of claim 1, wherein the home repair profile stores multiple home improvement recommendations.

6. The method of claim 5, further comprising:
transmitting, by the communications hardware, a home improvement selection request to the user device; and
receiving, by the communications hardware and from the user device, a selection including the home improvement recommendation, wherein transmitting the home repair notification to the user device occurs in response to receiving the selection.

7. The method of claim 5, further comprising:
automatically selecting, by the improvement recommendation engine, the home improvement recommendation from the multiple home improvement recommendations included in the home repair profile based on the home impact score, wherein transmitting the home repair notification to the user device occurs in response to automatically selecting the home improvement recommendation.

8. The method of claim 1, wherein transmitting the home repair notification comprises:
generating, by a property generation circuitry and based on the home improvement recommendation, a home improvement graphic, wherein the home improvement graphic depicts the home improvement recommendation on an illustration of the target property,
storing, by the property generation circuitry, the home improvement graphic in the home repair notification.

9. An apparatus for using aggregated housing data to provide personalized home improvement recommendations, the apparatus comprising:
communications hardware configured to:
receive information regarding a target property associated with a user; and
aggregate supplementary housing data;
improvement recommendation engine configured to:
determine an insight regarding the target property based on the information regarding the target property and the supplementary housing data;
generate, based on the insight, a home improvement recommendation;
store the home improvement recommendation in a home repair profile; and
the communications hardware further configured to:
transmit, based on the home improvement recommendation, a home repair notification to a user device, wherein the user device is associated with the user.

10. The apparatus of claim 9, wherein the improvement recommendation engine is further configured to:
compare the information regarding the target property to the supplementary housing data to identify a subset of the supplementary housing data, wherein the subset of the supplementary housing data comprises data about one or more properties included in the supplementary housing data that are most-similar to the target property;
derive occurrence of a plurality of home repairs from the subset of supplementary housing data; and
identify a home repair trend relevant to the target property from the plurality of home repairs, wherein the home repair trend comprises the insight regarding the target property.

11. The apparatus of claim 10, wherein the improvement recommendation engine is further configured to:
determine a frequency of occurrence for a plurality of home repair types represented by the plurality of home repairs; and
determine a particular home repair type that occurs with a frequency satisfying a predetermined threshold, wherein the home repair trend comprises the particular home repair type.

12. The apparatus of claim 9, wherein the improvement recommendation engine is further configured to:
derive a plurality of candidate recommendations based on the insight;
determine home impact score for each of the plurality of candidate recommendations; and
select a particular candidate recommendation having a highest home impact score as the home improvement recommendation.

13. The apparatus of claim 9, wherein the home repair profile stores multiple home improvement recommendations.

14. The apparatus of claim 13, wherein the communications hardware is further configured to:
transmit a home improvement selection request to the user device; and
receive, from the user device, a selection including the home improvement recommendation, wherein transmitting the home repair notification to the user device occurs in response to receiving the selection.

15. The apparatus of claim 13, wherein the improvement recommendation engine is further configured to:
automatically select the home improvement recommendation from the multiple home improvement recommendations included in the home repair profile based on the home impact score, wherein transmitting the home repair notification to the user device occurs in response to automatically selecting the home improvement recommendation.

16. The apparatus of claim 9, further comprises:
a property generation circuitry configured to:
generate a home improvement graphic based on the home improvement recommendation, wherein the home improvement graphic depicts the home improvement recommendation on an illustration of the target property,
store the home improvement graphic in the home repair notification.

17. A non-transitory computer-readable storage medium storing instructions that, when executed by an apparatus, cause the apparatus to:
receive information regarding a target property associated with a user;
aggregate supplementary housing data;
determine an insight regarding the target property based on the information regarding the target property and the supplementary housing data;
generate, based on the insight, a home improvement recommendation;
store the home improvement recommendation in a home repair profile; and,
transmit, based on the home improvement recommendation, a home repair notification to a user device, wherein the user device is associated with the user.

18. The non-transitory computer-readable storage medium of claim 17, wherein the instructions, when executed by the apparatus, further cause the apparatus to:
compare the information regarding the target property to the supplementary housing data to identify a subset of the supplementary housing data, wherein the subset of the supplementary housing data comprises data about one or more properties included in the supplementary housing data that are most-similar to the target property;
derive occurrence of a plurality of home repairs from the subset of supplementary housing data; and
identify a home repair trend relevant to the target property from the plurality of home repairs, wherein the home repair trend comprises the insight regarding the target property.

19. The non-transitory computer-readable storage medium of claim 18, wherein the instructions, when executed by the apparatus, further cause the apparatus to:
determine a frequency of occurrence for a plurality of home repair types represented by the plurality of home repairs; and
determine a particular home repair type that occurs with a frequency satisfying a predetermined threshold, wherein the home repair trend comprises the particular home repair type.

20. The non-transitory computer-readable storage medium of claim 17, wherein the instructions, when executed by the apparatus, further cause the apparatus to:
derive a plurality of candidate recommendations based on the insight;
determine home impact score for each of the plurality of candidate recommendations; and
select a particular candidate recommendation having a highest home impact score as the home improvement recommendation.
